(19) United States
(12) Patent Application Publication
(10) Pub. No.: US 2018/0326932 A1
(43) Pub. Date: Nov. 15, 2018

(54) AIR MOTION POWERED ENERGY HARVESTERS FOR VEHICLE WHEELS

(71) Applicant: Pygmalion Technologies, LLC, Humble, TX (US)

(72) Inventor: Roland E. Chemali, Humble, TX (US)

(73) Assignee: Pygmalion Technologies, LLC, Humble, TX (US)

(21) Appl. No.: 16/033,051

(22) Filed: Jul. 11, 2018

Related U.S. Application Data
(63) Continuation-in-part of application No. 15/656,687, filed on Jul. 21, 2017.
Application No. 15/656,687 is a continuation-in-part of application No. 15/408,881, filed on Jan. 18, 2017, now Pat. No. 10,023,017.

(51) Int. Cl. B60R 16/03; H02N 2/18; H02K 35/02

(52) U.S. Cl. CPC B60R 16/0307; B60C 23/12; H02K 35/02; H02N 2/186

(57) ABSTRACT

Air-motion powered devices may be attached to vehicle wheels to harvest energy from the air through which the vehicle passes. One illustrative energy harvester embodiment includes a body that attaches to a wheel of a vehicle to move with the wheel as the wheel rotates. An action member attached to the body is acted upon by air through which the vehicle moves, causing the action member to move relative to the body. The motion of the action member optionally drives a generator to generate electrical power. An illustrative method embodiment which may be implemented by a wheel-attached energy harvester includes: receiving with the action member an aerodynamic force from air through which the vehicle moves; deriving from the aerodynamic force motion of the action member relative to the body; and converting said motion into electrical power. The electrical power may be supplied to sensors, lights, or motors.

### CROSS-REFERENCE TO RELATED APPLICATIONS

The present application claims priority to co-pending U.S. application Ser. No. 15/656,687, titled “Air motion powered devices for vehicle wheels” and filed Jul. 21, 2017 by inventor Roland Chemali, and also claims priority to co-pending U.S. application Ser. No. 15/408,881, titled “Air-drag powered devices for vehicle wheels” and filed Jan. 18, 2017 by inventor Roland Chemali. Each of these applications is hereby incorporated herein by reference.

### BACKGROUND

By some recent estimates there are over 1 billion passenger vehicles in the world, with over a quarter of that number in the United States alone. The tires on the wheels of these vehicles are, for a variety of reasons, chronically underinflated. This underinflated condition increases carbon emissions while reducing fuel economy, tire life, and braking and steering performance, yet often goes uncorrected for extended periods of time due to the required effort and low priority associated with re-inflating the tires to proper levels.

Various efforts have been made to address this issue. Among the less successful efforts are various tire and wheel designs incorporating automatic inflation systems. It appears that these efforts have been unsuccessful for a number of reasons including: the cost of such systems, design flaws, and requirements for substantial modifications to the existing tire and wheel designs. It is believed that these issues are obstacles to retrofitting existing vehicle wheels, dooming most of these efforts to failure.

The most successful of these efforts is the incorporation of wireless pressure sensors in tire valve stems to detect underinflated conditions and to alert the driver of the need for such prompt action. Yet even this effort has met with limited success as drivers often postpone such action until it is convenient.

### SUMMARY

Accordingly, there is disclosed herein an energy harvester for use on vehicle wheels. One illustrative energy harvester embodiment includes a body that attaches to a wheel of a vehicle to move with the wheel as the wheel rotates. An action member attached to the body is acted upon by air through which the vehicle moves, causing the action member to move relative to the body. The motion of the action member optionally drives a generator to generate electrical power.

An illustrative method embodiment which may be implemented by a wheel-attached energy harvester includes: receiving with the action member an aerodynamic force from air through which the vehicle moves; deriving from the aerodynamic force motion of the action member relative to the body; and converting said motion into electrical power.

Each of the foregoing embodiments may be employed together with one or more of the following features in any suitable combination: (1) at least one sensor powered by the electrical power. (2) at least one light source powered by the electrical power. (3) the generator includes one or more piezoelectric elements that deform cyclically in response to the motion of the action member. (4) the generator includes one or more coils that move cyclically through a magnetic field in response to the motion of the action member. (5) the air causes the action member to reciprocate relative to the body. (6) the action member derives reciprocating motion from air drag on alternating surfaces of the action member. (7) the action member derives reciprocating motion from a variable drag force on the action member. (8) the action member is an airfoil reciprocated by a varying lift force from the air. (9) the air causes the action member to rotate relative to the body. (10) the action member is a propeller-style turbine rotated by flow of the air parallel to the turbine's axis. (11) the action member is a Savonius-style turbine rotated by drag from the air flowing perpendicular to the turbine's axis. (12) the action member is a Darrieus-style turbine rotated by lift from the air flowing perpendicular to the turbine's axis. (13) the action member is a vane in a trailing orientation kept by the air as the body turns with the wheel. (14) the method includes supplying the electrical power to a sensor or light source.

### BRIEF DESCRIPTION OF THE DRAWINGS

In the drawings:

FIG. 1 is a perspective view of an illustrative wheeled vehicle.

FIGS. 2A and 2B are a front and side section view of a wheel with an air motion powered device mounted on the valve stem.

FIGS. 3A and 3B are a front and side section view of a wheel with an air motion powered device mounted on a lug.

FIG. 4 is a graph of relative air speed versus time.

FIGS. 5A, 5B, and 5C are schematic diagrams of a first illustrative air motion powered air compressor.

FIGS. 6A and 6B are schematic diagrams of a second illustrative air motion powered air compressor.

FIGS. 7A and 7B are schematic diagrams of a third illustrative air motion powered air compressor.

FIGS. 8A and 8B are schematic diagrams of a fourth illustrative air motion powered air compressor.

FIG. 9 is an isometric view of an illustrative drag member.

FIG. 10 is a side view of a fifth illustrative air motion powered air compressor.

FIGS. 11A and 11B are front and side section view of a wheel with a sixth illustrative compressor.

FIGS. 12A and 12B are front and side section view of a wheel with a seventh illustrative compressor.

FIGS. 13A and 13B are front and side section view of a wheel with an eighth illustrative compressor.

FIGS. 14A and 14B are front and side section view of a wheel with a ninth illustrative compressor.

FIG. 15 is a side section view of an illustrative Schrader valve adapter.

FIG. 16 is a flow diagram of an illustrative inflation-maintenance method.

FIGS. 17A-17D are schematic views of various air motion powered generator embodiments.

It should be understood that the drawings and corresponding detailed description do not limit the disclosure, but on the contrary, they provide the foundation for understanding all modifications, equivalents, and alternatives falling within the scope of the appended claims.

### DETAILED DESCRIPTION

The process of converting ambient energy into a suitable form for a desired purpose is known as “energy harvesting”. The ambient energy employed by the wheel-mounted energy harvesters of the present disclosure is the motion of the air through which the vehicle passes. The moving air causes an action member to move relative to the body of energy harvester, and the energy harvester converts this relative motion into power for a desired purpose. Embodiments are described herein for at least three illustrative purposes: compressing air to maintain tire inflation levels, powering a wheel-mounted sensor, and powering a wheel-mounted light source.

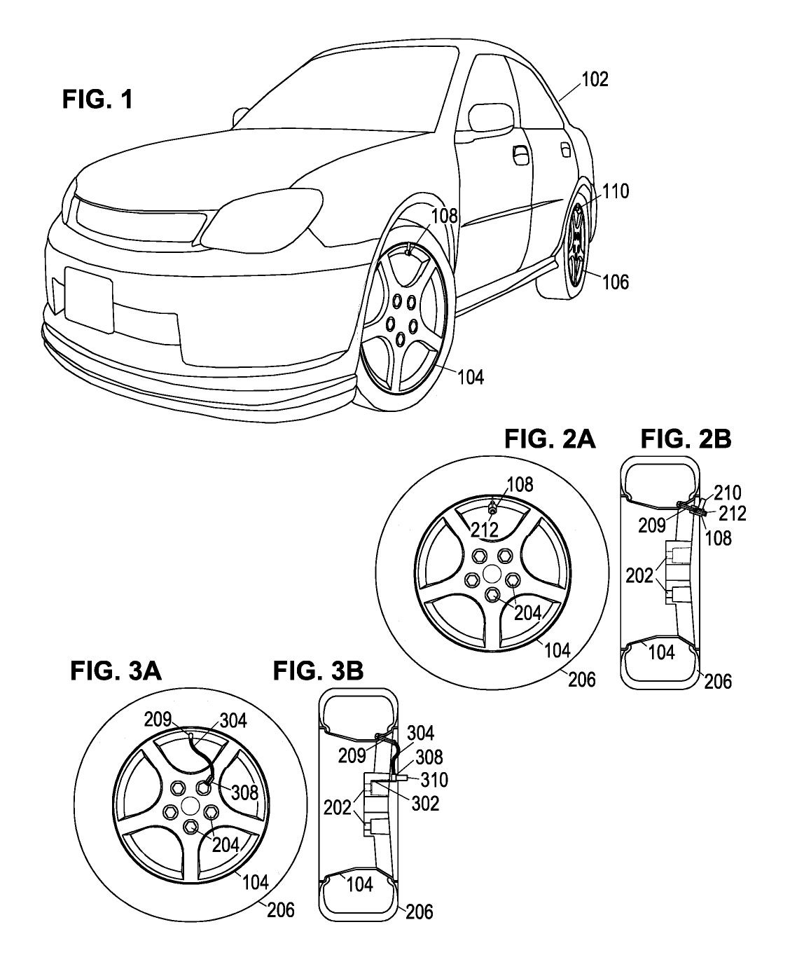

FIG. 1 shows an illustrative passenger vehicle 102 having wheels 104, 106 which have been retrofitted with air-motion powered energy harvesters 108, 110. Energy harvesters 108, 110 may be configured to convert ambient energy into compressed air, and when so configured, may be described as air motion powered air compressors. The illustrated vehicle is a sedan, but the following disclosure is applicable to all vehicles having inflatable tires including trucks, buses, vans, cars, carts, motorcycles, bicycles, trailers, dollies, and off-road transportation.

FIGS. 2A and 2B show wheel 104 with an illustrative air motion powered air compressor 108. Wheel 104 includes holes 202 for receiving wheel lugs (not shown). Lug nuts 204 thread onto the wheel lugs to secure the wheel 104 to the vehicle 102. Mounted to wheel 104 is an inflatable tire 206 which can be inflated or deflated via a valve stem 209. The valve stem 209 includes an integrated valve, which for automobile tires is conventionally a Schrader valve. By contrast, bicycle tires often employ Presta or Dunlop valves, which would also be compatible with at least some of the embodiments disclosed herein. In any event, the valve stem 209 may be equipped with an external screw thread to retain a dust cap for protecting the valve from debris.

Notably, Schrader valves include an internal pin that when depressed opens the valve to permit the passage of air. Inflation connectors for Schrader valves generally, though not necessarily, include a center prong to depress the valve's internal pin during inflation. Schrader valves with calibrated opening pressures are commercially available and can be opened by simply applying a specified overpressure (e.g., 20 or 30 psi above the tire's internal air pressure) to the valve inlet.

The illustrative air motion powered air compressor 108 mounts on the valve stem 209 in place of the dust cap. The compressor 108 may be screwed onto the valve stem's external thread and/or clamped in place. Any other suitable mounting mechanism can alternatively be employed. For use with Schrader valves, the air outlet of the compressor 108 preferably includes a center prong to depress the valve's internal pin, but alternative implementations employ air pressure alone to open the valve. Embodiments including the center prong to keep the Schrader valve open may include precautions against parasitic air leakage so as to avoid slowly deflating the tires to which they are attached. Such precautions may include equipping the compressor's air outlet with a rubber gasket or O-ring seal to assure a robust seal against the valve stem, and a reliable backup check valve that seals tightly when the tire pressure exceeds the outlet pressure. Moreover, rather than being coupled to the outlet connector, the center prong may be coupled to a portion of the body that is automatically removed or withdrawn in the event of damage to the compressor.

The compressor's mass is preferably minimized to avoid undue unbalancing of the wheel, with a value below 25 grams being considered desirable and attainable. Some contemplated compressor embodiments include a sleeve or open protective housing that encloses and reinforces the valve stem to protect the valve stem against fatigue and to stabilize the compressor body relative to the wheel. Alternatively, or in addition, buttress fins may stabilize the compressor body against the wheel. Preferably, however, the compressor mass and aerodynamic forces are kept to values that would not necessitate such reinforcement or stabilization.

The illustrative compressor 108 includes an action member 210 that extends from the compressor body. The illustrated action member 210 is a small rectangular vane approximately one centimeter wide and two centimeters long. The vane lies substantially within a plane extending axially and radially from the center of the wheel to efficiently intercept, near the top and bottom of the vane's orbit, a horizontal air flow from the vehicle's motion. As the compressor 108 rotates with the wheel, the action member 210 alternately exposes its opposite sides to the air through which the vehicle moves.

Air impacting and moving around the vane (or other action member) creates a drag force. As the action member exposes its opposite sides to the flow, the drag force is exerted in opposing directions. The action member is flexibly attached to the compressor body so that the alternating drag force causes the action member to reciprocate relative to the compressor body. The compressor 108 uses the reciprocating motion of the action member 210 to drive a positive displacement or rotary compression mechanism, thereby producing compressed air which may be used to inflate and maintain the tire at a desired inflation level.

To minimize the risk of damage, the vane may be formed from a resilient material such as plastic or metal and designed to accommodate significant bending without breaking. Additional protection for the vane may be provided in the form of an open protective housing that protects the vane from impacts by stationary objects or large debris, yet enables the passing air flow to impact the vane.

The illustrated air compressor 108 further includes a bypass inlet 212. With the bypass inlet, air can be supplied to the tire without first removing the compressor 108. In embodiments lacking the bypass inlet, manual inflation can be performed by first removing the compressor to expose the valve stem 209, which is then used in the conventional fashion. Afterwards, the compressor may be re-attached to the valve stem to maintain the new inflation level.

FIGS. 3A and 3B show wheel 104 with an alternative embodiment of air motion powered air compressor 308. Compressor 308 is attached to a bracket 302 which is secured to the wheel by a lug nut 204. A valve stem extender 304 couples the valve stem 209 to the air outlet of the air compressor 308. The illustrated compressor 308 lacks a bypass inlet, as the valve stem extender 304 may be readily removed and re-secured at will. The compressor 308 includes an action member 310, again shown as a small rectangular vane oriented substantially in a plane extending axially and radially from the center of the wheel. Vane 310 is hinged along a radial edge, whereas vane 210 was hinged along a substantially axial edge. Any action member orientation that presents a significant cross-section in a plane extending axially and radially from the center of the wheel will experience the alternating drag force referenced previously. A wide variety of hinging, pivoting, translating, twisting, and/or flexing configurations are available to convert the alternating drag force into reciprocating motion of the action member relative to the compressor body.

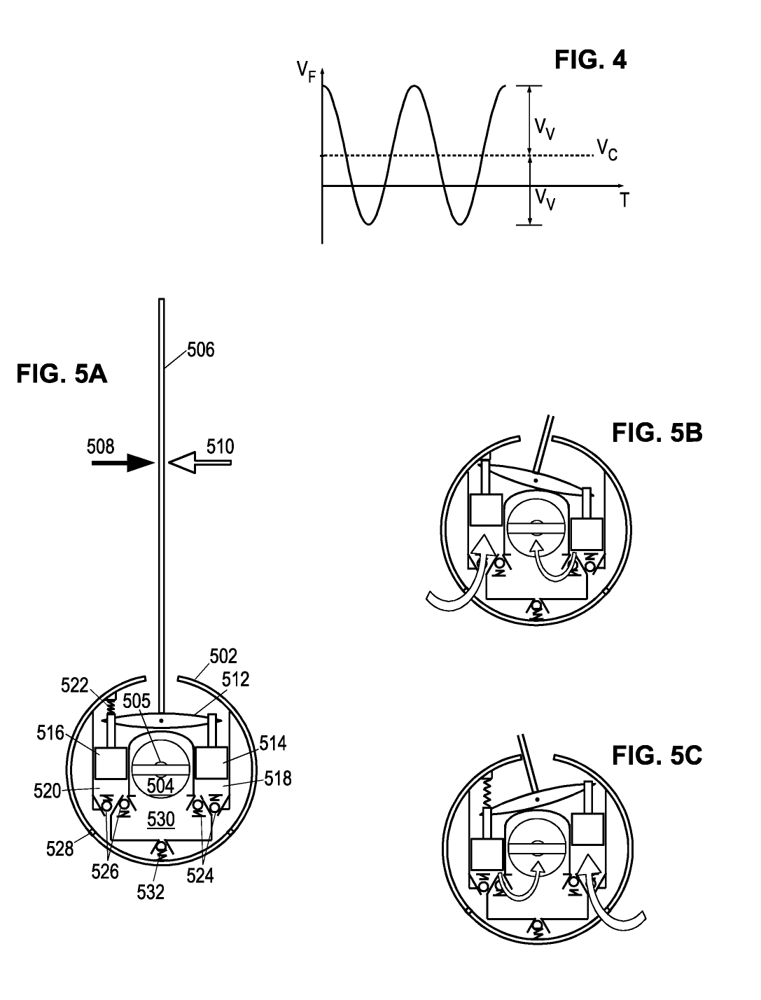

FIG. 4 shows the velocity of passing air on the face of an action member V_{F}, where the speed of the vehicle is Vᵥ and the speed of the compressor's rotation relative to the wheel's center is V_{c}. (The vane is presumed to be collocated with the compressor body for this analysis, but this is not a requirement.) Assuming that the air itself is substantially stationary as the vehicle moves through it, the relative air speed is equal to the compressor's velocity, whose components are:

vₓ=(Rω)+rω cos ωt (1)

v_{y}=−rω sin ωt (2)

where R is the outer radius of the tire, ω is the angular velocity of the wheel (ratio of the vehicle's speed Vᵥ to R), r is the radial distance of the action member from the center of the wheel, and t is time. If the action member is a flat vane turning as the tire rotates, the face of the vane is exposed to these velocity components in a varying fashion, yielding a relative velocity against the face:

$$\begin{matrix}{v}_{f} = {v}_{x} cos ω t - {v}_{y} sin ω t & ( 3 ) \\ {v}_{f} = R ω ( \frac{r}{R} + cos ω t ) = {V}_{C} + {V}_{v} cos ω t & ( 4 )\end{matrix}$$

where V_{c}=rω is the orbital velocity of the compressor.

Thus, as shown in FIG. 4, the vane face moves through the air with the relative velocity having an average value V_{c} determined by the ratio of the compressor's radial distance from the center to the outer radius of the wheel. This ratio can theoretically vary from zero (compressor positioned at the wheel's hub) to one (compressor positioned at the outer rim of the tire), causing the average value to vary from zero to the vehicle's speed Vᵥ. Around this average value, the relative air velocity varies sinusoidally, with an amplitude equal to the vehicle's speed Vᵥ.

Note that in all but the most extreme case (compressor positioned at the outer rim of the tire), the relative velocity alternates between positive and negative values, indicating that the air alternately strikes the front (positive) face of the vane and the back (negative) face of the vane. The alternation occurs with the same frequency as the rotation of the tire. The frequency is the vehicle speed divided by the tire circumference. At 22.3 m/s (50 mph), standard automobile tires rotate at approximately 9 to 15 hertz, providing roughly 400 to 700 rotations per kilometer (or 700-1100 per mile).

Given the relative air velocity, it becomes possible to determine the drag force in accordance with the equation:

$${F}_{D} = \frac{1}{2} ρ {C}_{D} {Av}_{f}^{2} \qquad ( 5 )$$

where ρ is the mass density of air, A is the impinged cross section of the action member, and C_{D} is the drag coefficient. The drag coefficient of a vane perpendicular to the flow is approximately 1.28. For the moment, we take the size of the vane as 1×2 cm, for a reference area of 2 cm². Air has an approximate density of 1.225 kg/m³. With these values, the drag force becomes:

F_{D}=v_{f}²(1.57×10⁻⁴) N (6)

when velocity is in m/s. For a vane located at the center of the wheel on a vehicle moving 22.3 m/s, the positive and negative peaks of the drag force are approximately 0.08 N (0.28 ounces). For a vane located 60% of the way toward the outer rim of the tire, the positive drag force peak is 0.2 N (0.72 ounces) and the negative peak is 0.01 N (0.045 ounces).

For comparison, a piston with a diameter of 1.5 mm ( 1/16 inch) would require 0.4 N to compress air 0.2 MP (32 psi) above atmospheric pressure. (To overpressure a Schrader valve with a calibrated opening pressure, the required force could be as much as double this value.) A lever, gear, or other form of mechanical advantage can readily amplify the force received by the action member by a factor of 2-10, or even more if compound mechanisms are employed.

If the piston operates with a stroke length of about 1.5 mm, each stroke can provide about 7×10⁻⁴ cm³ of compressed air. Each mile traveled can therefore provide over 0.5 cm³, which over the course of a typical year is adequate to replace over 10% of the air volume in most automobile tires. Stroke lengths up to about a centimeter are feasible and would yield commensurately larger volumes.

FIG. 5A shows an illustrative air motion powered air compressor with a compressor body 502 having an air outlet 504 that attaches to the valve stem of an inflatable tire on a wheel, causing the body 502 to turn with the wheel as the vehicle moves. An optional center prong 505 is included to depress the central pin of a Schrader valve in the tire stem. Action member 506 extends from the compressor body 502 to alternately present opposing surfaces to air through which the vehicle moves. A front side of action member 506 may receive a drag force 508 when the compressor body 502 is near the top end of its motion, and a back side may receive a drag force 510 when the body 502 is near the bottom of its motion.

FIG. 5A is not drawn strictly to scale, as the diameter of the body 502 is contemplated to be about 1 cm and the length of the action member is contemplated to be 2-3 cm. Of course other dimensions would also be suitable and are also contemplated. The action member 506 connects to a rocker arm 512 that pivots to drive the rods of two pistons 514, 516 with a mechanical advantage factor of four or more, reciprocating them within their respective cylinders 518, 520. An optional spring 522 may be provided to balance the asymmetry of the drag forces 508, 510. The ideal force exerted by such a spring would be half of the difference between the drag forces as adjusted by the mechanical advantage factor, but would never need to exceed the force needed to drive the piston 516 in the absence of any aerodynamic forces. The spring may need to be positioned on the other piston rod for compressors used on the opposite side of the vehicle, or the vane could be directed radially inward on the wheel rather than radially outward.

In at least some contemplated embodiments, the walls of cylinders 518, 520 are borosilicate glass and the pistons 514, 516 are graphite, providing for self-lubricating, seal-less, low-friction operation with tight tolerances. Each cylinder includes a valve assembly 524, 526, that causes the pistons' reciprocating motion to draw air from the environment (via perforations 528) into the cylinders, pressurize, and expel the air into a collection chamber 530, from whence it exits via air outlet 504 to enter the tire as illustrated in FIGS. 5B and 5C. The use of two pistons doubles the volume of air injected on each cycle. A pressure limiting valve 532 connects to the collection chamber to release air when the air pressure exceeds a predetermined threshold value.

The illustrated valves 524, 526, 532, are ball-and-seat check valves. Other valve designs are also contemplated including poppet valves and swing check valves (also termed flapper valves or clapper valves). Moreover, the pistons may be replaced by bellows, diaphragms, or other such cavity size modifier devices that apply positive displacements to convert reciprocating motion into compressed air.

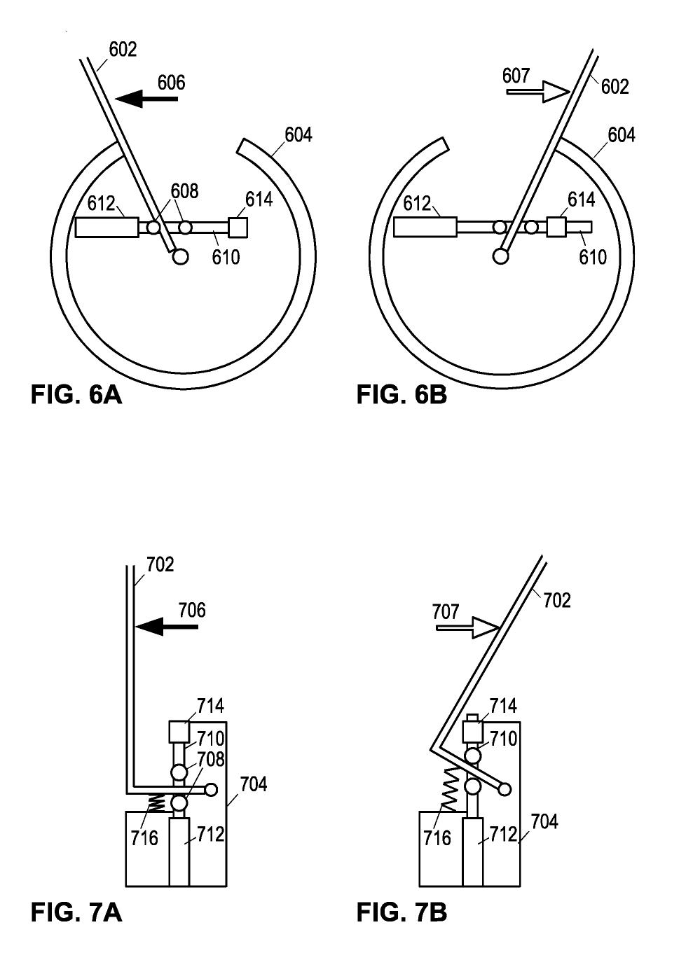

Alternative air compressor embodiments are shown in FIGS. 6A-6B, 7A-7B, and 8A-8B to demonstrate the variety of configurations that may be employed for deriving compressed air from reciprocating motion of the action member. In the embodiment of FIGS. 6A-6B, the action member 602 pivots with respect to the compressor body 604, which turns with the wheel to present alternating surfaces to the air through which the vehicle is moving, thereby receiving alternating drag forces 606, 607 that cause the action member to reciprocate. In FIG. 6A, the front surface receives drag force 606, forcing the action member 602 to the left. The action member 602 is trapped between pins 608 on sliding rod 610, which connects to a piston inside cylinder 612. A guide 614 keeps the sliding rod 610 aligned with the cylinder 612. Due to the trapping pins 608, the sliding rod 610 forces the piston into the cylinder 612 when the action member moves left. Conversely, when the action member moves right due to drag force 607 on the back surface, the trapping pins force the sliding rod 610 to withdraw relative to the cylinder 612. The alternating drag forces 606, 607, thus cause the piston to reciprocate inside cylinder 612. A valve arrangement (not shown) causes the reciprocating piston to draw in air, pressurize the air, and expel the pressurized air via an air outlet.

The trapping pins 608 are positioned near the pivot point, magnifying the drag forces 606, 607 exerted further out on the action member. A mechanical advantage factor of 10 or more may be readily achieved in this fashion. Note further that the front drag force 606 is employed to compress the air, and the back drag force 607 is employed merely to draw in fresh air, making the orientation of the action member an important consideration. The compressors for the left and right sides of the vehicle would need to be configured accordingly, or the action members directed inward on one side and outward on the other.

In the embodiment of FIGS. 7A-7B, action member 702 again pivots with respect to compressor body 704, trapped between pins 708 attached to sliding rod 710 to reciprocate the rod relative to the cylinder 712 and a guide 714 that keeps the rod aligned with the cylinder 712. The rod 710 reciprocates a piston within cylinder 712 in response to motion of the action member 702 in response to alternating drag forces 706, 707. An optional spring 716 is shown to reduce asymmetry of the alternating drag forces 706, 707.

Relative to the embodiment of FIGS. 6A-6B, the cylinder and sliding rod are re-oriented, potentially reducing the overall compressor size. Moreover, the action member may be extended in a more axial direction rather than a radial direction, perhaps assuring greater exposure to air flow around the vehicle. Finally, the “L”-shape of action member 702 may make a higher mechanical advantage factor feasible, enabling the use of a larger piston area.

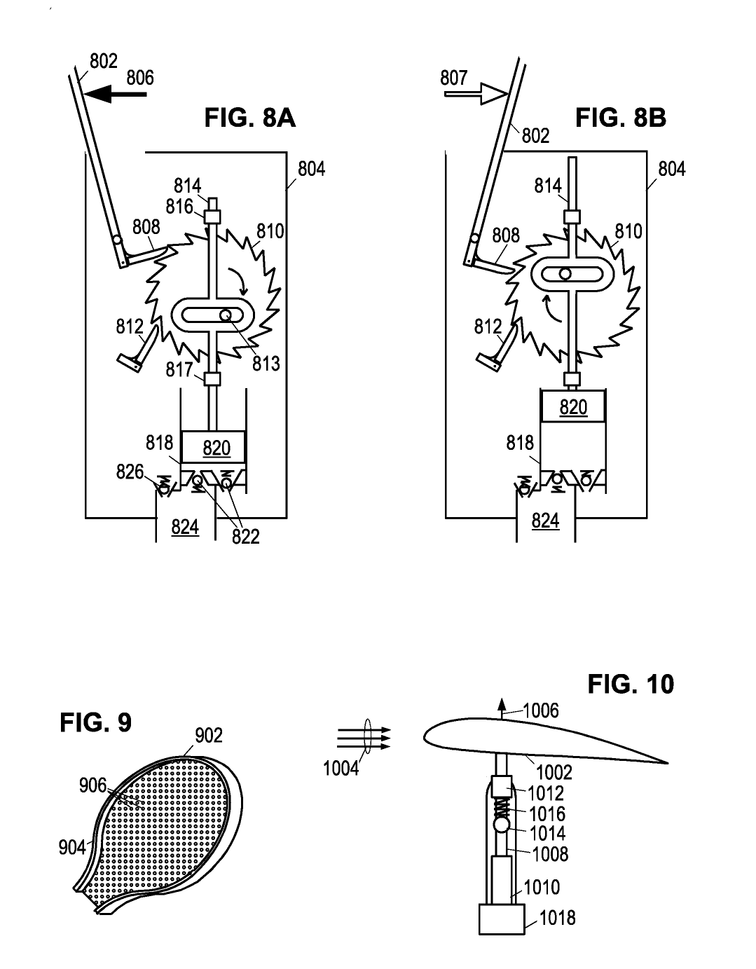

In the embodiments of FIGS. 8A-8B, action member 802 pivots with respect to body 804, reciprocating in response to alternating drag forces 806, 807. Attached to the action member 802, a pawl 808 engages a gear 810, advancing the gear when the action member 802 moves left. A stationary pawl 812 engages the gear 810, holding it in place as the action member 802 moves right. Thus reciprocating motion of action member 802 is converted into clockwise rotation of gear 810 by operation of this ratchet mechanism. The gear includes an attached pin 813 that engages a window of slider bar 814. As the gear 810 rotates, pin 813 causes slider bar 814 to reciprocate upward & downward in guides 816, 817. A piston 820 is connected to the slider bar 814 to reciprocate within cylinder 818. A valve arrangement 822 enables the reciprocating piston 820 to draw in air, pressurize the air, and expel the compressed air to air outlet 824. A pressure limiting valve 826 may be provided to release excess pressure. Relative to the previous embodiments, the use of a ratchet mechanism enables many reciprocations of the action member to be aggregated into a combine operation on the piston 820, enabling the use of a significantly larger piston.

For ease of explanation, the illustrated action members of the foregoing embodiments have been substantially flat, rectangular vanes. While such action members are easy to manufacture and hence inexpensive, other forms may be employed for enhanced performance. FIG. 9 shows one example of an enhanced action member 902. The shape of action member 902 is rounded and equipped with a rim 904 make the action member more “cup-like”, thereby increasing its drag coefficient. Perforations 906 reduce the mass of the action member while further enhancing the drag coefficient. Moreover, the shape widens near its distal end to increase the lever arm associated with the drag forces. The use of such techniques enables a larger drag force to be received for a given mass, or alternatively, enables a lighter action member to be employed for driving the compressor.

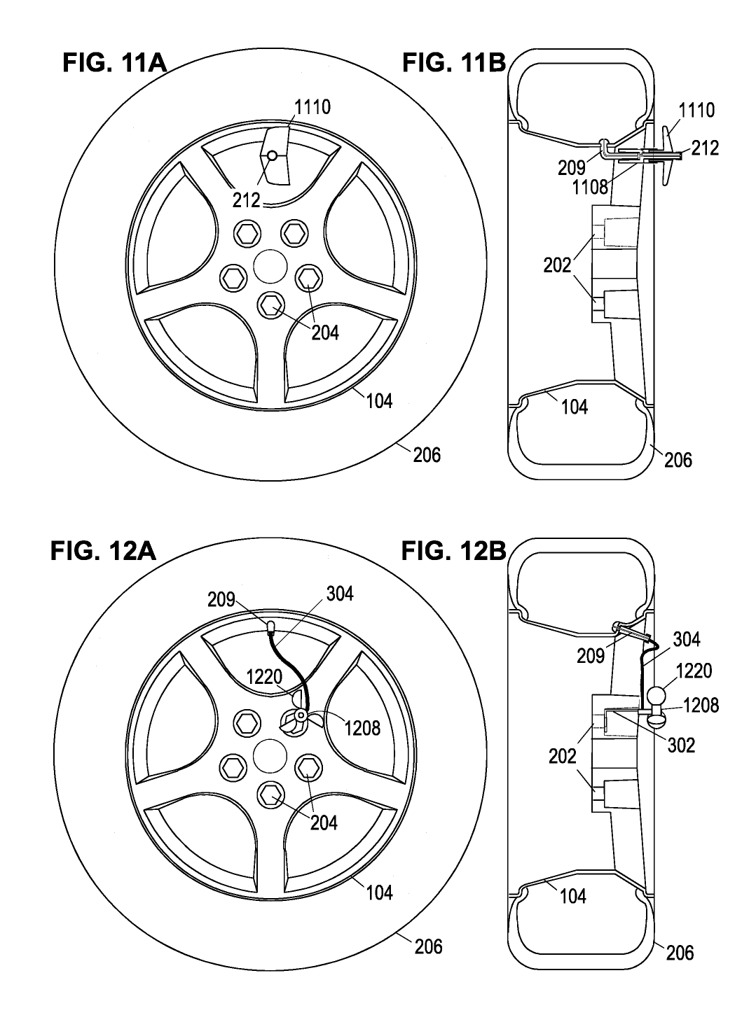

In the foregoing illustrative embodiments, the action member has been driven by drag forces, but other aerodynamic forces such as lift may be used. As shown in FIG. 10, the action member may take the form of an airfoil 1002 that, when exposed to an air flow 1004, experiences a lift force 1006 with a component perpendicular to the air flow. As the speed and direction of the air flow 1004 varies due to the wheel's rotation, the lift force varies in a fashion similar to that of the drag force given in equation (5). For properly designed airfoils, the lift coefficient is greater than the drag coefficient, potentially enabling the lift force to be greater (and provide greater variation) than the drag force. The lift force 1006 on the airfoil 1002 draws the piston rod 1008 (and piston) outwardly from cylinder 1010 via guide 1012, causing a pin 1014 to compress a spring 1016 as ambient air is drawn into the cylinder 1010. As the flow velocity drops, spring 1016 drives the piston back into the cylinder 1010, compressing air and delivering the compressed air through a valve 1018 into the tire. In alternative embodiments, the airfoil 1002 is attached to a lever arm that acts through a pivot to increase the mechanical advantage of the force applied to the spring and piston. The illustrated airfoil exploits the variation of air flow velocity and direction to induce reciprocation of the action member, and should be oriented forward near the top of the compressor's orbit to optimize performance (see, e.g., FIG. 11A). This directional dependence can be eliminated with a symmetric version of the airfoil, at the cost of a suboptimal lift coefficient. To provide reciprocation, such a symmetric airfoil would rely solely on the variation of air flow speed due to the wheel's rotation.

FIGS. 11A-11B show an alternative air compressor embodiment 1108 that, similar to the embodiment of FIG. 10, obtains reciprocation of the action member 1110 from the lift force of an air flow with velocity and direction variation caused by the tire's rotation. Air compressor 1108 varies from the embodiment of FIG. 10 primarily in that it employs an annular piston and cylinder so as to accommodate bypass inlet 212 through the centerline of the device.

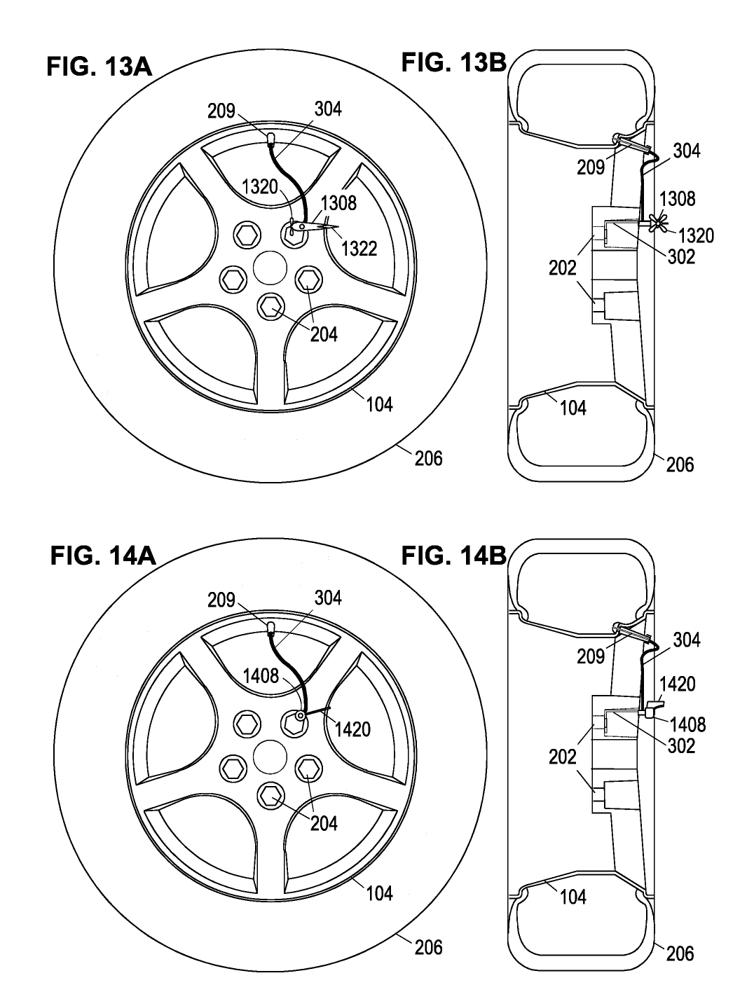

Other alternative air compressor embodiments are shown in FIGS. 12A-12B, 13A-13B, and 14A-14B to demonstrate that the air compressors do not have to rely on reciprocation of the action members employed by previous examples, but can instead be powered by rotation of the action members. In FIGS. 12A and 12B, the air compressor 1208 has a Savonius-style turbine as an action member 1220. The turbine axis is substantially parallel to the wheel axis, and the turbine rotates in response to the drag forces from the air through which the compressor 1208 moves. Alternatively, a Darrieus-style turbine may be employed to provide rotation in response to lift forces from the air through which the compressor 1208 moves. As yet another alternative, FIGS. 13A-13B show an illustrative compressor 1308 that employs a propeller-style turbine as the action member 1320 with a tail 1322 that keeps the axis of the turbine oriented substantially parallel to the airflow. In still another illustrative embodiment, FIGS. 14A-14B show an illustrative compressor 1408 in which the action member 1420 is a vane or tail fin that the airflow keeps in a relatively fixed orientation downstream of the compressor's body as the body rotates relative to the action member 1420.

In each of these rotation-based embodiments, a shaft within the compressor 1208 rotates with, or in response to, the turbine's rotation. In some contemplated embodiments, the shaft is connected to an arm or cam that converts the shaft's rotation into reciprocation of a piston or other cavity-size modifier (e.g., diaphragm, bellows) having valves that covert the reciprocation into compressed air for delivery to the valve stem 209. In other contemplated embodiments, the shaft drives a peristaltic pump, scroll compressor, or other rotary pump mechanism to provide compressed air to the valve stem 209.

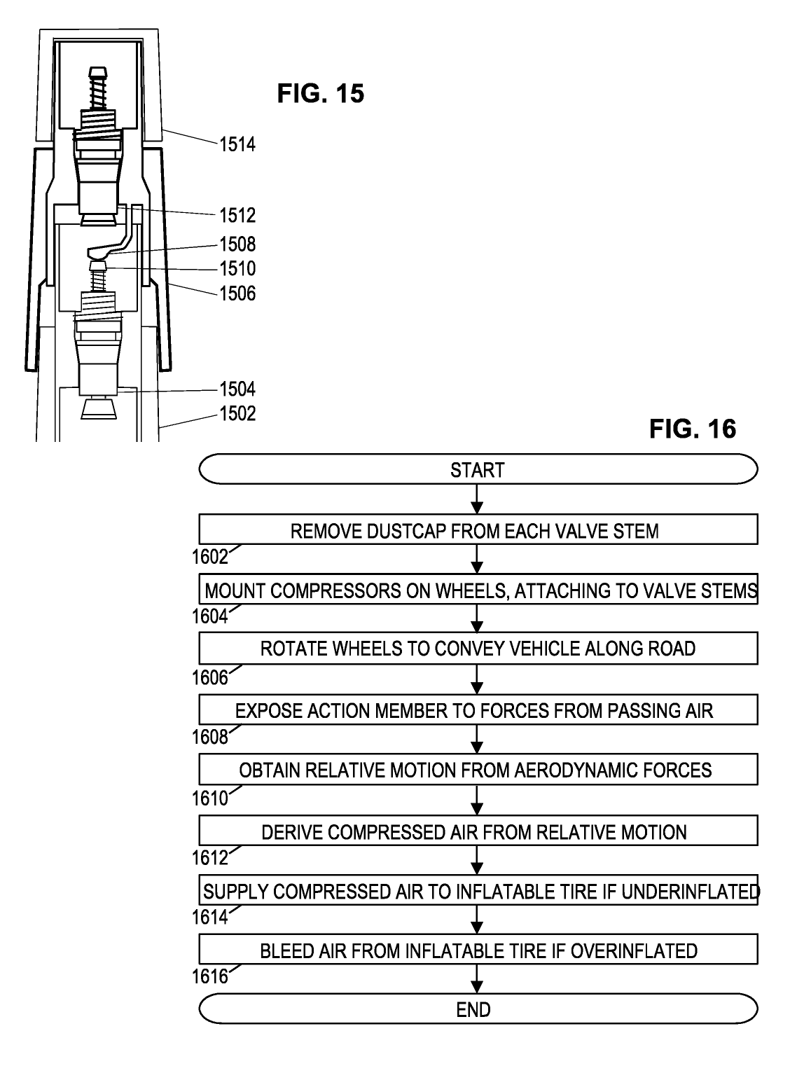

As previously mentioned, Schrader valves can be opened either by depressing the internal pin or by simply applying enough overpressure. As the integrated Schrader valves on many existing tires may be uncalibrated (or calibrated to an unknown value), it may be desirable to disable them while providing an alternative valve or pressure regulation mechanism. FIG. 15 shows a valve stem 1502 equipped with an illustrative adapter 1506 that disables the integrated Schrader valve 1504 with a prong 1508 that depresses the internal pin 1510 when the adapter 1510 is threaded on to the valve stem. Depressing the pin 1510 in this fashion maintains the integrated Schrader valve 1504 in an “open” position. The adapter 1506 includes a calibrated Schrader valve 1512 that provides the desired operating characteristics, e.g., opening at a relatively small overpressure such as 3 psi. FIG. 15 also shows a dust cap 1514 to protect the calibrated Schrader valve 1512. The dust cap 1514 can be removed as an air compressor or valve stem extender is secured to the valve stem 1502 via the adapter 1506. In at least some contemplated air compressor embodiments, the prong 1508 and calibrated Schrader valve 1512 are integrated into the compressor's valve stem connector.

In view of the foregoing disclosure, we now turn to an illustrative method for employing air motion powered air compressors for maintaining tire pressure, represented in FIG. 16 by a flow diagram. The method begins in block 1602 with the manufacturer, owner, or operator of a vehicle (hereafter “user”) removing the dust caps from the valve stems on each wheel. In block 1604, the user mounts an air motion powered air compressor to each wheel, attaching the compressor outlets to the valve stems. In some embodiments, the air compressors are screwed or clamped directly onto the external threads of the valve stems. In other embodiments, the air compressors are mounted elsewhere (e.g., on a bracket secured by a lug nut) and connected to the valve stems via a commercially-available valve stem extender. The action members relying on alternating drag forces (“drag” members) may be aligned in a plane extending axially and radially from the center of the wheel. Action members relying on lift forces and/or providing rotation relative to the compressor body may have their axis of rotation extending parallel to the wheel axis or (in the case of the propeller-style turbine) configured to orient their axis of rotation parallel to the direction of air flow.

In block 1606, the user operates the vehicle, e.g., employing a motor to rotate the wheels and convey the vehicle along a road. In block 1608, the compressors move with the wheels, exposing their action member to aerodynamic forces from the passing air. In block 1610, the compressors obtain motion of their action members relative to the compressor body (e.g., reciprocating or rotary motion), and in block 1612, the compressors derive compressed air from the reciprocating motion.

In block 1614, the compressors supply compressed air to the tire via the valve stem if the tire is underinflated. Such underinflation may be detected if the tire pressure is below a target value (e.g., 35 psi) by more than a predetermined threshold (e.g., 3 psi). In block 1616, the compressors bleed air from the tire via the tire stem if the tire is overinflated. Overinflation may be detected if the tire pressure exceeds the target value. As an alternative to bleeding off pressure, the valve arrangement may prevent additional air from being injected into the tire, optionally trapping air in the cylinder. In at least some configurations, such trapped air inhibits motion of the action member.

Though the blocks of FIG. 16 are illustrated and described in sequence for explanatory purposes, many of the associated operations may occur concurrently and/or out of the order in which they are illustrated.

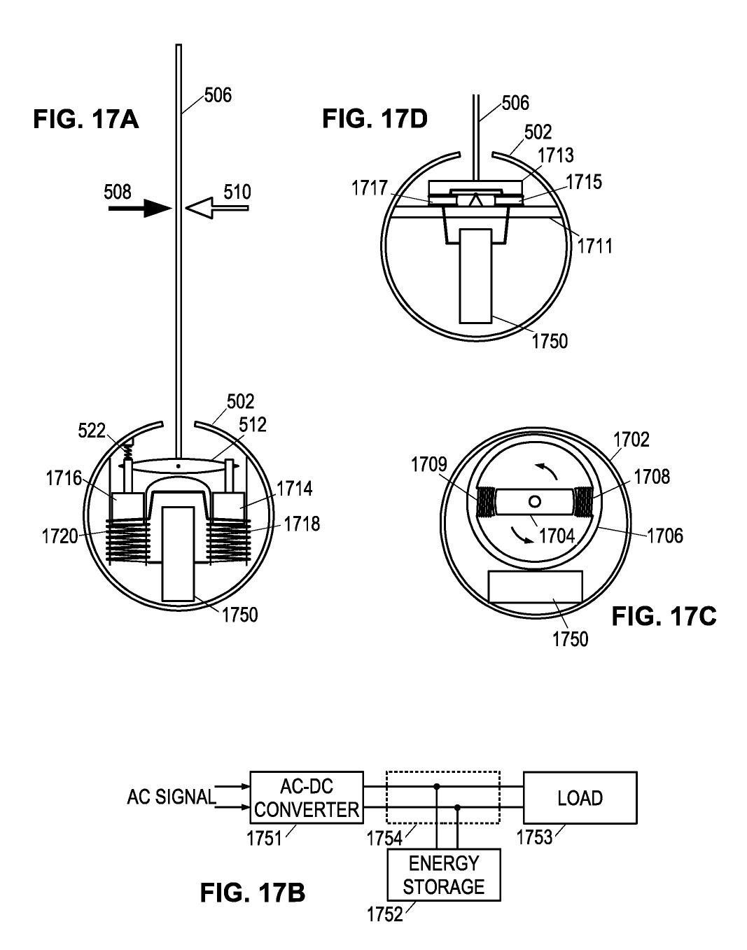

The embodiments described above may compress air to maintain tire inflation levels, but as previously mentioned, the disclosed energy harvesters may operate to serve other purposes. For example, the pistons and cylinders of the FIG. 5A embodiment can be replaced by magnets and wire coils so that electric power is generated by the reciprocating motion of the action member. This variation is shown in FIG. 17A. Pistons 514 and 516 are replaced by magnets 1714 and 1716, while cylinders 518 and 520 are replaced by wire coils 1718 and 1720. As action member 506 reciprocates relative to the body 502, the rocker arm 512 drives the magnets in and out of the wire coils, inducing an alternating electrical current in accordance with the well-known principles of electromagnetic induction. A circuit 1750 converts the alternating current (AC) signal into direct current (DC) electric power, which can be which can be stored in a battery or capacitor and employed for powering sensors or lights.

FIG. 17B shows an illustrative circuit 1750 having an AC-DC converter 1751, an energy storage unit 1752, and a load 1753. An optional management module 1754 may control the flow of power among the other elements to, e.g., regulate the DC voltage and/or accumulate a predetermined charge on the energy storage unit 1752 before enabling the load 1753. The converter 1751 converts the AC signal into a DC signal. Suitable converters are well known in the literature and may employ, e.g., a transformer, one or more diodes, and/or an active rectifier bridge. Energy storage unit 1752 may employ, e.g., a capacitor, a super-capacitor, and/or a rechargeable battery. Load 1753 may be, e.g., a light, a sensor, and/or an electric motor. In some embodiments, load 1753 may further include a wireless communications transmitter or transceiver to communicate measurements and status information to, e.g., an electronic control unit (ECU) that controls an information display for the driver of the vehicle. Illustrative sensors may include sensors for tire pressure, tire mileage/wear, wheel balance, curb proximity, and other parameters. Illustrative lights may include light-emitting-diodes (LEDs), electroluminescent panels, or spark gaps, any of which may be employed for aesthetic effects. The electric motor may drive, e.g., an air compressor.

FIG. 17C shows an energy harvester embodiment driven by rotary motion of the action member. As the action member rotates relative to the body 1702, it rotates one or more magnets 1704 within an armature 1706 having one or more wire coils 1708, 1709. Suitable multipole rotary generator designs are well known in the literature. The motion of the magnet(s) relative to the coil(s) generates electrical power in the form of an alternating current that is supplied to the electrical circuit 1750 described previously.

FIG. 17D shows another energy harvester embodiment that may be driven by reciprocating motion of the action member 506 relative to the body 502. A rigid base 1711 is hingedly coupled to the action member 506. The action member 506 is rigidly attached to a cross arm 1713. As the aerodynamic force on action member 506 varies or oscillates, the cross arm alternately compresses piezoelectric elements 1715 and 1717. As they deform (compress and expand), the piezoelectric elements generate an AC signal to power the electrical circuit 1750.

Numerous modifications, equivalents, and alternatives will become apparent to those skilled in the art once the above disclosure is fully appreciated. It is intended that the following claims be interpreted to embrace all such modifications, equivalents, and alternatives where applicable.

1. An energy harvester that comprises:
a body that attaches to a wheel of a vehicle to move with the wheel as the wheel rotates; and
an action member attached to the body to be acted upon by air through which the vehicle moves, the air causing motion of the action member relative to the body.

2. The harvester of claim 1, wherein the motion of the action member drives a generator to generate electrical power.

3. The harvester of claim 2, further comprising at least one sensor powered by the electrical power.

4. The harvester of claim 2, further comprising at least one light source powered by the electrical power.

5. The harvester of claim 2, wherein the generator comprises one or more piezoelectric elements that deform cyclically in response to the motion of the action member.

6. The harvester of claim 2, wherein the generator comprises one or more coils that move cyclically through a magnetic field in response to the motion of the action member.

7. The harvester of claim 2, wherein the air causes the action member to reciprocate relative to the body.

8. The harvester of claim 7, wherein the action member derives reciprocating motion from air drag on alternating surfaces of the action member.

9. The harvester of claim 7, wherein the action member derives reciprocating motion from a variable drag force on the action member.

10. The harvester of claim 7, wherein the action member is an airfoil reciprocated by a varying lift force from the air.

11. The harvester of claim 2, wherein the air causes the action member to rotate relative to the body.

12. The harvester of claim 11, wherein the action member is a propeller-style turbine rotated by flow of the air parallel to the turbine's axis.

13. The harvester of claim 11, wherein the action member is a Savonius-style turbine rotated by drag from the air flowing perpendicular to the turbine's axis.

14. The harvester of claim 11, wherein the action member is a Darrieus-style turbine rotated by lift from the air flowing perpendicular to the turbine's axis.

15. The harvester of claim 11, wherein the action member is a vane kept in a trailing orientation by the air as the body turns with the wheel.

16. A method implemented by an energy harvester having a body attachable to a wheel of a vehicle and an action member coupled to the body, the method comprising:
receiving with the action member an aerodynamic force from air through which the vehicle moves;
deriving from the aerodynamic force motion of the action member relative to the body; and
converting said motion into electrical power.

17. The method of claim 16, further comprising supplying the electrical power to a sensor or light source.

18. The method of claim 16, wherein said converting includes cyclically deforming one or more piezoelectric elements.

19. The method of claim 16, wherein the motion includes reciprocation of the action member relative to the body.

20. The method of claim 16, wherein the motion includes rotation of the action member relative to the body.

21. The method of claim 16, further comprising using the electrical power to drive an air compressor.

22. The harvester of claim 2, wherein the electrical power drives an air compressor.
